(19) United States
(12) Patent Application Publication
(10) Pub. No.: US 2026/0221357 A1
(43) Pub. Date: Jul. 30, 2026

(54) PUSH SWITCH

(71) Applicant: Alps Alpine Co., Ltd., Tokyo (JP)

(72) Inventor: Hidetaka ATO, Miyagi-ken (JP)

(21) Appl. No.: 19/454,701

(22) Filed: Jan. 21, 2026

(30) Foreign Application Priority Data
Jan. 24, 2025 (JP) 2025-010872

(51) Int. Cl. H01H 13/14

(52) U.S. Cl. CPC H01H 13/14

(57) ABSTRACT

A push switch includes a housing having a storing portion and a fixed contact provided on the bottom of the storing portion, a movable contact member, which is placed in the storing portion and comes into contact with the fixed contact when a top thereof is pressed and thereby the movable contact member performs a reverse operation, and a rubber stem formed from a soft elastic material and placed on the upper surface of the housing so as to cover the storing portion. The rubber stem presses the top of the movable contact member through a pressing portion when a pressing manipulation is performed for a manipulation portion. The rubber stem applies a load to the top of the movable contact member through the pressing portion during a period in which the movable contact member returns from a reversed state to an initial state.

### CLAIM OF PRIORITY

This application claims benefit of Japanese Patent Application No. 2025-010872 filed on Jan. 24, 2025, which is hereby incorporated by reference.

### BACKGROUND OF THE INVENTION

### 1. Field of the Invention

The present invention relates to a push switch.

### 2. Description of the Related Art

A switch device disclosed in Japanese Unexamined Patent Application Publication No. 2011-113652 has a structure in which a stem presses a movable contact member placed in a storing portion in a case so that the movable contact member performs a reverse operation and thereby comes into contact with a fixed contact member.

With the switch device in Japanese Unexamined Patent Application Publication No. 2011-113652, however, the stem is horizontal in an initial state. During a manipulation to press the stem downward, therefore, the horizontal part of the stem needs to be elastically deformed so as to be pulled downward. This elastic deformation becomes an obstacle, so a large manipulation load was needed for the pressing manipulation.

Another problem with the switch device in Japanese Unexamined Patent Application Publication No. 2011-113652 is that when the reverse operation and return operation of the movable contact member are performed at high speed, the movable contact member may generate large sounds during the reverse operation and return operation.

### SUMMARY OF THE INVENTION

A push switch in an embodiment has: a housing having a storing portion as well as a fixed contact provided on the bottom of the storing portion; a movable contact member placed in the storing portion, the movable contact member being configured to come into contact with the fixed contact when a top is pressed and the movable contact member thereby performs a reverse operation; and a rubber stem that is formed from a soft elastic material and is placed on the upper surface of the housing so as to cover the storing portion, the rubber stem pressing the top of the movable contact member through a pressing portion when a pressing manipulation is performed for a manipulation portion. The rubber stem applies a load to the top of the movable contact member through the pressing portion during a period in which the movable contact member returns from a reversed state to an initial state.

A push switch in an embodiment can reduce a manipulation load required for a pressing manipulation and can suppress a sound generated by a movable contact member during an operation.

### BRIEF DESCRIPTION OF THE DRAWINGS

FIG. 1 is a perspective view illustrating the outside shape of a push switch in an embodiment;

FIG. 2 is an exploded perspective view of the push switch in the embodiment;

FIG. 3 is a sectional view of the push switch in the embodiment; and

FIG. 4 is a sectional view illustrating the operation of a rubber stem in the push switch in the embodiment.

### DESCRIPTION OF THE PREFERRED EMBODIMENTS

An embodiment will be described below with reference to the drawings. In the description below, the Z-axis direction in the drawings will be taken as the up-down direction, the Y-axis direction in the drawings will be taken as the left-right direction, and the X-axis direction in the drawings will be taken as the front-back direction, for convenience of explanation. In addition, the positive Z-axis direction will be taken as the upward direction, the positive Y-axis direction will be taken as the right direction, and the positive X-axis direction will be taken as the front direction. These directions indicate only relative positional relationships in the device and do not limit manipulation directions or a direction in which to install the device. All constituent components, the relative positional relationships of which are equivalent in the device, including constituent components that are installed or manipulated in different directions, are included in the scope of rights of the present invention.

### General Outline Of A Push Switch 100

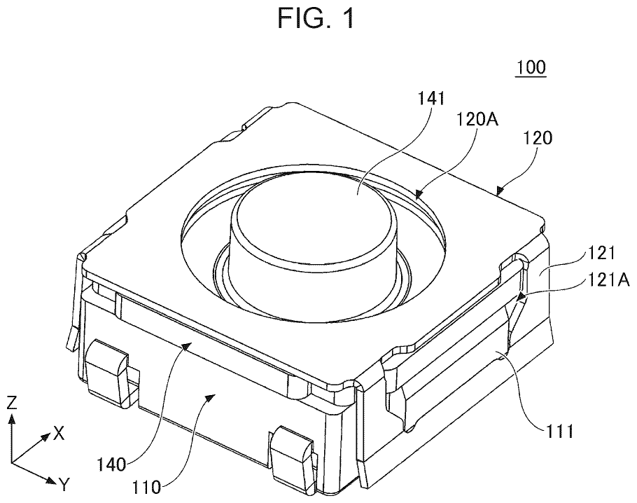

FIG. 1 is a perspective view illustrating the outside shape of the push switch 100 in an embodiment. As illustrated in FIG. 1, the push switch 100 has a structure in which a rubber stem 140 and a metal cover 120 are provided on an upper surface 110A of a housing 110 so that the rubber stem 140 and metal cover 120 are overlaid on each other and in which a base 142 of the rubber stem 140 is covered with the metal cover 120.

Also, as illustrated in FIG. 1, an opening 120A in a circular shape is formed in the central portion of the metal cover 120. A manipulation portion 141 in a columnar shape is provided in the central portion of the rubber stem 140 so as to pass through the opening 120A. Thus, the manipulation portion 141 of the rubber stem 140 protrudes upward (in the positive Z-axis direction) from the opening 120A.

With the push switch 100, the manipulator can press the manipulation portion 141 of the rubber stem 140 downward (in the negative Z-axis direction). In response to the pressing manipulation, switching from a switch-off state to a switch-on state is possible.

### Structure Of The Push Switch 100

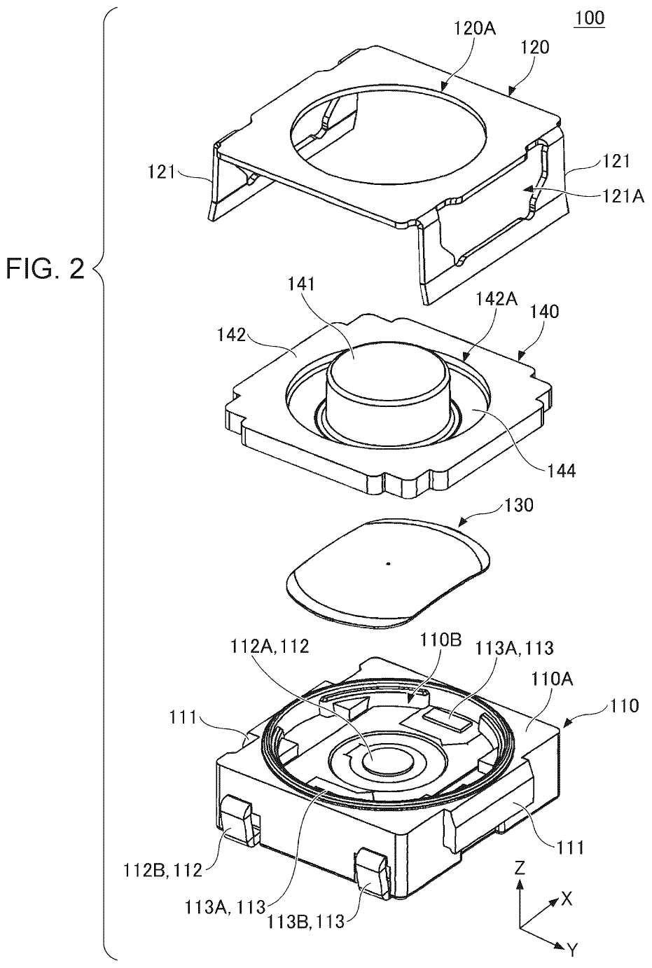

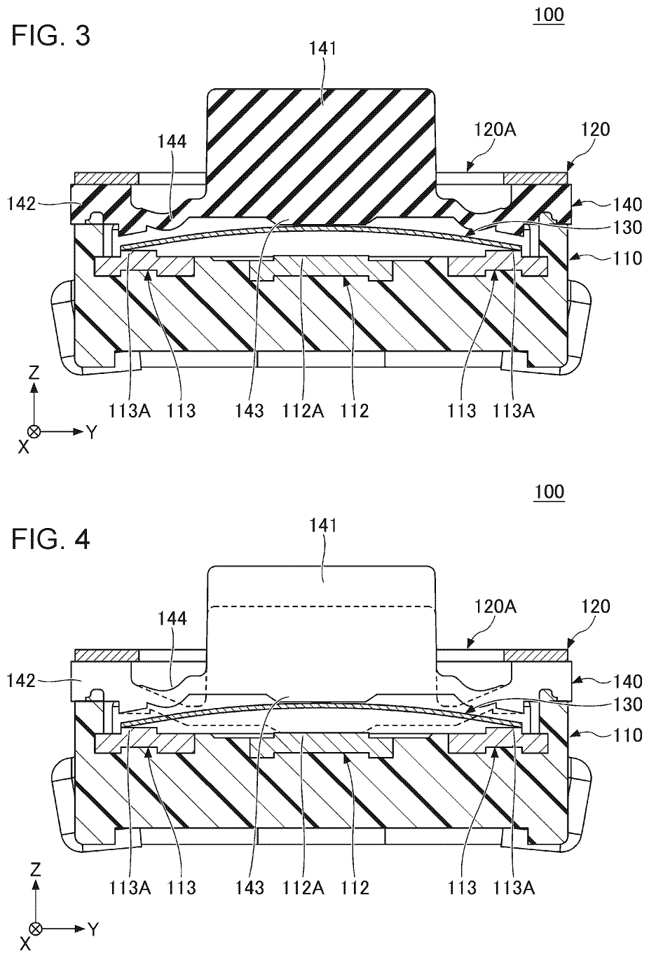

FIG. 2 is an exploded perspective view of the push switch 100 in the embodiment. FIG. 3 is a sectional view of the push switch 100 in the embodiment. As illustrated in FIGS. 2 and 3, the push switch 100 has the housing 110, the metal cover 120, a movable contact member 130, and the rubber stem 140.

The housing 110 is a container-like member in a rectangular parallelepiped shape that is thin in the up-down direction (Z-axis direction). The housing 110 is in a substantially square shape in top view. The housing 110 has a storing portion 110B, which is recessed downward from the upper surface 110A and is circular in plan view from above (from the positive Z-axis direction). The movable contact member 130 is stored in the interior of the storing portion 110B. The housing 110 is formed by, for example, insert-molding in which a relatively hard insulating material (such as a hard resin material or the like) is used.

Protrusions 111 are formed on a pair of side surfaces, aligned in the left-right direction, of the housing 110 so as to extend outward, one on each side surface. When the metal cover 120 is attached to the upper surface 110A of the housing 110, each protrusion 111 is fitted to the interior of an opening 121A in a hook 121 of the metal cover 120, locking the hook 121. Thus, the metal cover 120 can be fixed to the housing 110.

A central fixed contact 112A and a pair of peripheral fixed contacts 113A aligned in the front-back direction are provided on the bottom of the storing portion 110B in the housing 110.

The central fixed contact 112A is disposed in the central portion of the bottom of the storing portion 110B so as to face the rear surface of the top (in the central portion) of the movable contact member 130.

The pair of peripheral fixed contacts 113A aligned in the front-back direction are disposed on both outsides, aligned in the front-back direction, of the central fixed contact 112A on the bottom of the storing portion 110B, one peripheral fixed contact 113A on each outside. A pair of arc-shaped edges, aligned in the front-back direction, of the movable contact member 130 are placed on the pair of peripheral fixed contacts 113A aligned in the front-back direction, one edge on each peripheral fixed contact 113A.

A central fixed contact member 112 and peripheral fixed contact members 113 are embedded in the bottom of the housing 110 by insert-molding. Both the central fixed contact member 112 and the peripheral fixed contact member 113 are formed from a conductive plate material (such as, for example, a metal plate).

The central fixed contact 112A is integrally formed as part of the central fixed contact member 112. The central fixed contact member 112 has a pair of external connection terminals 112B aligned in the front-back direction, one of which is disposed so as to protrude from a side surface of the housing 110 on the front side (on the positive X-axis side) and the other of which is disposed so as to protrude from another side surface of the housing 110 on the rear side (on the negative X-axis side).

The pair of peripheral fixed contacts 113A aligned in the front-back direction are integrally formed as part of the peripheral fixed contact member 113. The peripheral fixed contact member 113 has a pair of external connection terminals 113B aligned in the front-back direction, one of which is disposed so as to protrude from a side surface of the housing 110 on the front side (on the positive X-axis side) and the other of which is disposed so as to protrude from another side surface of the housing 110 on the rear side (on the negative X-axis side).

The movable contact member 130 is disposed in the storing portion 110B in the housing 110. A metal reversing dome 131 is a member that is formed from a thin metal plate in a domed shape (protruding upward), the metal reversing dome 131 being operable to reverse. The metal reversing dome 131 is in an oblong shape the longitudinal direction of which matches the front-back direction (X-axis direction) in plan view from above (from the positive Z-axis direction).

The pair of arc-shaped edges, aligned in the front-back direction, of the movable contact member 130 are placed on the pair of peripheral fixed contacts 113A aligned in the front-back direction on the bottom of the storing portion 110B in the housing 110, one edge on each peripheral fixed contact 113A. Thus, the movable contact member 130 is stably supported by the pair of arc-shaped edges aligned in the front-back direction and is electrically connected to each of the pair of peripheral fixed contacts 113A aligned in the front-back direction.

The movable contact member 130 is a so-called reversing spring. When its top (central portion) is pressed from above, if a predetermined pressing load is exceeded, the top (central portion) rapidly undergoes elastic deformation (reverse operation) into a concave shape. Thus, the rear portion of the top (central portion) of the movable contact member 130 comes into contact with the central fixed contact 112A disposed in the central portion of the bottom of the storing portion 110B in the housing 110. As a result, an electrical connection is established between the central fixed contact 112A and each of the pair of peripheral fixed contacts 113A aligned in the front-back direction through the movable contact member 130. When the pressing of the top (central portion) of the movable contact member 130 is canceled with it reversed, the movable contact member 130 returns to an initial state, in which the movable contact member 130 is in a convex shape, due to its elastic force.

The rubber stem 140 is a member on which the manipulator performs a pressing manipulation downward (in the negative Z-axis direction). The rubber stem 140 is overlaid on the upper surface 110A of the housing 110. Thus, the rubber stem 140 closes the storing portion 110B in the housing 110. Since the metal cover 120 is disposed so as to be overlaid on the upper side (on the positive Z-axis side) of the base 142, which will be described later, the rubber stem 140 is sandwiched between the metal cover 120 and the upper surface 110A of the housing 110.

The rubber stem 140 is formed from a soft elastic material such as, for example, silicone rubber. The rubber stem 140 has the manipulation portion 141, the base 142, a pressing portion 143, and an elastically deforming portion 144.

The base 142 is a horizontal flat plate-like portion disposed around the manipulation portion 141. The base 142 is in a substantially square shape in plan view from above (from the positive Z-axis direction). An opening 142A in a circular shape is formed in the central portion of the base 142.

The manipulation portion 141 is a columnar portion disposed in the central portion of the rubber stem 140 (in the central portion in the inside of the opening 142A in the base 142). The manipulation portion 141 passes through the opening 120A in the metal cover 120 and protrudes upward (in the positive Z-axis direction) from the opening 120A in the metal cover 120, making the manipulation portion 141 ready for a pressing manipulation by the manipulator.

The pressing portion 143 is a convex portion disposed so as to protrude downward from the central portion of the lower surface of the manipulation portion 141. While a pressing manipulation is not performed for the manipulation portion 141, the lower surface of the pressing portion 143 is in contact with the top (central portion) of the movable contact member 130, as illustrated in FIG. 3. When the manipulator performs a pressing manipulation for the manipulation portion 141, the pressing portion 143 moves downward (in the negative Z-axis direction) together with the manipulation portion 141, so the lower surface of the pressing portion 143 presses the top (central portion) of the movable contact member 130.

The elastically deforming portion 144 is a film-like portion that is disposed inside the opening 142A in the base 142 so as to link the inner circumference of the opening 142A in the base 142 and the outer circumference of the manipulation portion 141 together. The elastically deforming portion 144 is in a circular ring shape enclosing the manipulation portion 141 in plan view from above (from the positive Z-axis direction). The elastically deforming portion 144 supports the manipulation portion 141 and elastically deforms, so the elastically deforming portion 144 can move the manipulation portion 141 in the front-back direction (Z-axis direction).

The metal cover 120 is a horizontal flat plate-like member formed from a metal. The metal cover 120 is in a square shape in top view. The metal cover 120 is overlaid on the upper surface of the base 142 of the rubber stem 140. The metal cover 120 is fixed to the housing 110 in a state in which the metal cover 120 presses the base 142 of the rubber stem 140.

The metal cover 120 is formed by, for example, machining of a metal plate by a machining method such as stamping. The opening 120A in a circular shape, through which the manipulation portion 141 of the rubber stem 140 protrudes upward (in the positive Z-axis direction), is formed in the central portion of the metal cover 120 in plan view from above (from the positive Z-axis direction).

The hooks 121 are suspended downward from a pair of edges aligned in the left-right direction, which are part of the outer circumference of the metal cover 120, one hook 121 from each edge. The hook 121 has the opening 121A, into which the protrusion 111 disposed on the relevant side surface of the housing 110 is inserted. Thus, the hook 121 is locked by the lower surface of the protrusion 111, so the metal cover 120 can be fixed to the housing 110.

### Operation Of The Push Switch 100

With the push switch 100 in the embodiment, while a pressing manipulation by the manipulator is not performed for the manipulation portion 141 of the rubber stem 140, the manipulation portion 141 of the rubber stem 140 is in its initial state in which the manipulation portion 141 is at the highest position and the movable contact member 130 is also in its initial state in which it is convex upward. At this time, the pair of arc-shaped edges, aligned in the front-back direction, of the movable contact member 130 are in contact with the pair of peripheral fixed contacts 113A aligned in the front-back direction, one edge in contact with each peripheral fixed contact 113A, but are not in contact with the central fixed contact 112A. Thus, while a pressing manipulation by the manipulator is not performed for the manipulation portion 141 of the rubber stem 140, the push switch 100 in the embodiment is in the switch-off state.

With the push switch 100 in the embodiment, when the manipulator performs a pressing manipulation for the manipulation portion 141 of the rubber stem 140, the manipulation portion 141 and pressing portion 143 of the rubber stem 140 move downward and the lower surface of the pressing portion 143 of the rubber stem 140 presses the top (central portion) of the movable contact member 130 downward. Thus, the movable contact member 130 undergoes elastic deformation (reverse operation) into a concave shape, so the rear portion of the top (central portion) of the movable contact member 130 comes into contact with the central fixed contact 112A. As a result, electrical continuity is established between the central fixed contact 112A and each of the pair of peripheral fixed contacts 113A aligned in the front-back direction through the movable contact member 130, so the push switch 100 in the embodiment enters the switch-off state.

With the push switch 100 in the embodiment, when the manipulator then cancels the pressing manipulation for the manipulation portion 141 of the rubber stem 140, the movable contact member 130 returns from the reversed state to the initial state, in which the movable contact member 130 is in a convex shape, due to its elastic force. At this time, the movable contact member 130 lifts up the manipulation portion 141 and pressing portion 143 of the rubber stem 140, so the movable contact member 130 returns the manipulation portion 141 and pressing portion 143 of the rubber stem 140 to their initial positions.

### Load Applying Function Of The Rubber Stem 140

FIG. 4 is a sectional view illustrating the operation of the rubber stem 140 in the push switch 100 in the embodiment. In FIG. 4, hatching indicating a cross section of the rubber stem 140 is omitted.

In a no-load state (that is, a state in which neither the manipulation portion 141 nor the pressing portion 143 is lifted up by the movable contact member 130), the rubber stem 140 is in a state in which the manipulation portion 141 and pressing portion 143 have moved downward (in the negative Z-axis direction) up to a height position at which the lower surface of the pressing portion 143 comes into contact with the central fixed contact 112A, as indicated by the dotted lines in FIG. 4. At this time, the elastically deforming portion 144 forms a surface inclined downward from the same side as the base 142 (the outer circumference side) toward the manipulation portion 141 (toward the inner circumference). Similarly, even when the rubber stem 140 is in a state in which the movable contact member 130 is reversed and thereby is in contact with the central fixed contact 112A and a slight load is thereby applied, the elastically deforming portion 144 may form a surface inclined downward from the same side as the base 142 (the outer circumference side) toward the manipulation portion 141 (toward the inner circumference).

Particularly, in this embodiment, since the elastically deforming portion 144 is in a circular ring shape in plan view from above and forms a downward inclined surface over the entire circumference of the circular ring shape in the no-load state, so the elastically deforming portion 144 is in a bowl shape. Similarly, even when the rubber stem 140 is in a state in which the movable contact member 130 is reversed and thereby is in contact with the central fixed contact 112A and a slight load is thereby applied, the elastically deforming portion 144 may be in a bowl shape.

When the movable contact member 130 is placed in the storing portion 110B in the housing 110 as indicated by the sloid lines in FIG. 4, the manipulation portion 141 and pressing portion 143 of the rubber stem 140 are lifted up (in the positive Z-axis direction) by the top of the movable contact member 130. At this time, the elastically deforming portion 144 elastically deforms and thereby forms a surface inclined upward from the same side as the base 142 (the outer circumference side) toward the manipulation portion 141 (toward the inner circumference). In addition, an intermediate portion between the same side as the base 142 (the outer circumference side) and the same side as the manipulation portion 141 (the inner circumference side) sags downward. Thus, the elastically deforming portion 144 generates a reaction force (that is, a force with which the elastically deforming portion 144 attempts to return to its previous shape) downward (in the negative Z-axis direction).

The rubber stem 140 can constantly apply a load to the top of the movable contact member 130 through the lower surface of the pressing portion 143 by using this reaction force of the elastically deforming portion 144 to urge the manipulation portion 141 and pressing portion 143 downward (in the negative Z-axis direction).

Thus, while a pressing manipulation by the manipulator is not performed for the manipulation portion 141 (that is, the manipulation portion 141 is at the initial position) as indicated by the sloid lines in FIG. 4, the rubber stem 140 may be in a state in which the rubber stem 140 applies a preload to the top of the movable contact member 130 through the lower surface of the pressing portion 143 due to the reaction force of the elastically deforming portion 144. This preload is generated by the own weight of the central portion of the rubber stem 140 and the force, of the elastically deforming portion 144, with which it attempts to return to its previous shape.

During a period in which the movable contact member 130 changes from the initial state (in a convex shape) to the reversed state (in a concave shape) in response to the reverse operation, the rubber stem 140 may apply, through the lower surface of the pressing portion 143, a load to the top of the movable contact member 130 due to the reaction force of the elastically deforming portion 144, and the manipulation portion 141 and pressing portion 143 can move downward (in the negative Z-axis direction) by following the top of the movable contact member 130.

With the push switch 100 in the embodiment, therefore, elastic deformation of the elastically deforming portion 144 does not become an obstacle when the manipulation portion 141 and pressing portion 143 move downward (in the negative Z-axis direction) in response to a pressing manipulation. This makes it possible to reduce a manipulation load required for a pressing manipulation.

With the push switch 100 in the embodiment, therefore, since the pressing portion 143 of the rubber stem 140 can remain in contact with the top of the movable contact member 130 during the reversion operation of the movable contact member 130, it is possible to absorb vibration of the movable contact member 130 to suppress a sound generated by the movable contact member 130 during the reverse operation.

During a period in which the movable contact member 130 returns from the reversed state (in a concave shape) to the initial state (in a convex shape) in response to the return operation, the rubber stem 140 applies, through the lower surface of the pressing portion 143, a load to the top of the movable contact member 130 due to the reaction force of the elastically deforming portion 144, and the manipulation portion 141 and pressing portion 143 can move upward (in the positive Z-axis direction) by following the top of the movable contact member 130.

With the push switch 100 in the embodiment, therefore, the speed of the return operation of the movable contact member 130 can be reduced, so it is possible to suppress a sound generated by the movable contact member 130 during the return operation.

With the push switch 100 in the embodiment, therefore, since the pressing portion 143 of the rubber stem 140 can remain in contact with the top of the movable contact member 130 during the return operation of the movable contact member 130, it is possible to absorb vibration of the movable contact member 130 to suppress a sound generated by the movable contact member 130 during the return operation.

With the push switch 100 in the embodiment, therefore, the effect of the tension force of the elastically deforming portion 144 is reduced, so a click ratio can be raised.

This completes the description of an embodiment of the present invention. However, the present invention is not limited to the embodiment. Various variations and modifications are possible without departing from the intended scope, described in the claims, of the present invention.

What is claimed is:

1. A push switch comprising:
a housing having a storing portion as well as a fixed contact provided on a bottom of the storing portion;
a movable contact member having a top, the movable contact member being placed in the storing portion, the movable contact member being configured to come into contact with the fixed contact when the top is pressed and the movable contact member thereby performs a reverse operation; and
a rubber stem having a manipulation portion and a pressing portion, the rubber stem being formed from a soft elastic material and being placed on an upper surface of the housing so as to cover the storing portion, the rubber stem pressing the top of the movable contact member through the pressing portion when a pressing manipulation is performed for the manipulation portion; wherein
the rubber stem applies a load to the top of the movable contact member through the pressing portion during a period in which the movable contact member returns from a reversed state to an initial state.

2. The push switch according to claim 1, wherein while the pressing manipulation is not performed, the rubber stem applies a preload to the top of the movable contact member through the pressing portion.

3. The push switch according to claim 1, wherein the rubber stem applies a load to the top of the movable contact member through the pressing portion during a period in which the movable contact member changes from the initial state to the reversed state.

4. The push switch according to claim 1, wherein: the rubber stem further has a base placed on the upper surface of the housing as well as an elastically deforming portion that links the base and the manipulation portion together; and in a state in which the movable contact member is reversed and thereby is in contact with the fixed contact, the elastically deforming portion forms a surface inclined downward from the same side as the base toward the manipulation portion.

5. The push switch according to claim 4, wherein in a state in which the movable contact member is reversed and thereby is in contact with the fixed contact, the elastically deforming portion is in a bowl shape.

6. The push switch according to claim 4, further comprising a metal cover that covers the base of the rubber stem and presses the base of the rubber stem against the upper surface of the housing.
